(19) United States
(12) Patent Application Publication
(10) Pub. No.: US 2021/0408573 A1
(43) Pub. Date: Dec. 30, 2021

(54) BATTERY FOR A MOTOR VEHICLE AS WELL AS MOTOR VEHICLE AND MANUFACTURING METHOD THEREFORE

(71) Applicant: AUDI AG, Ingolstadt (DE)

(72) Inventors: Walter SCHMIEDER, Hepberg (DE); Tamas GYULAI, Pfaffenhofen an der Ilm (DE)

(73) Assignee: AUDI AG, Ingolstadt (DE)

(21) Appl. No.: 17/326,552

(22) Filed: May 21, 2021

(30) Foreign Application Priority Data
Jun. 30, 2020 (DE) 102020117191.9

(51) Int. Cl. H01M 10/04; H01M 50/209; B60R 16/04; H01M 10/658; H01M 50/271

(52) U.S. Cl. CPC H01M 10/0468; H01M 50/209; H01M 2220/20; H01M 10/658; H01M 50/271; B60R 16/04

(57) ABSTRACT

A battery for an at least partially electrically drivable motor vehicle. The battery includes a battery pack with a plurality of battery cells, a frame enclosing the battery pack, which frame at least partially covers each of the battery cells on a shell surface of the respective battery cells, and a battery housing with an insertion opening for receiving the battery pack. The battery further includes a pretensioning device having a pretensioning unit which is designed to apply a pretensioning force onto the battery pack on a first side of the frame.

### FIELD

The present invention relates to a battery for an at least partially electrically drivable motor vehicle. The present invention also relates to a corresponding motor vehicle with and a manufacturing method for such a battery.

A battery within the meaning of the invention comprises at least one and in particular a plurality of electrically conductively interconnected battery cells. In this case, such a battery cell can be designed as a prismatic cell, a pouch cell, or a cylindrical cell, for example. The battery is preferably designed as a so-called high-voltage battery, which is configured to provide an electrical voltage in the range of more than 60 volts, in particular in the range of several 100 volts. Such a high-voltage battery can be arranged in a motor vehicle, where it can supply an electrical consuming unit, in particular a drive motor, with electrical energy.

### BACKGROUND

Various approaches are known from the prior art whereby such a battery cell has a long service life when operated as intended and can be operated particularly safely in the event of damage, for example an internal short circuit. For example, a pretensioning force can be applied to the battery cell or to a battery module comprising a plurality of battery cells in order to compensate for swelling of the battery cell(s) that shortens the service life. Furthermore, thermal insulation can be provided which prevents or delays thermal propagation of the battery cell(s). US 2019/0312323 A1 describes a thermal management system comprising a cell bank with several batteries and a cell frame for aligning the batteries on sweat bands. A spring may be disposed between an edge of the cell bank and a battery of a battery stack to compress the batteries and a thermal interface material between the batteries so that contact and heat transfer between the batteries is increased.

US 2019/0363392 A1 discloses a battery module with a battery cell stack having a plurality of battery cells and a housing enclosing the battery cell stack. The battery module further comprises an elastic element which is connected to two inner sides of the housing and is designed to apply a uniform pressure to the battery cells when swelling occurs on the battery cells.

Furthermore, DE 29 25 248 A1 discloses a measurement of the state of charge of rechargeable galvanic elements with swelling electrodes and alkaline electrolytes. Individual cells positioned next to one another are arranged between at least one fixed plate and one movable plate, the movable plate being connected to a spring assembly (for example, made up of several cup springs), via which a predetermined pretension can be set.

In known pretensioned high-voltage batteries, each cell module has a plurality of battery cells arranged within a module housing, in which the module housing may increase the weight of the battery. Furthermore, a complex design and construction of each of the cell modules is required, for example, to absorb a force caused by swelling of the battery cells (so-called swelling force) and to prevent at least one of the battery cells from thermal runaway in the event of damage.

### SUMMARY

Against this backdrop, the object of the present invention is to provide an improved design for a battery of the type described at the outset, which is particularly light and, furthermore, simple to manufacture. Furthermore, the object of the present invention is to provide a motor vehicle with such a battery and a corresponding manufacturing method.

This object is achieved according to the invention by means of the subject matters of the independent claims. Advantageous refinements of the invention are described by the dependent claims, the following description, and the figures.

The improved design is based on the idea of dispensing with an arrangement of the battery cells in respective cell modules and arranging the battery cells in a frame enclosing the battery pack in order to apply a pretensioning force to the battery by means of a pretensioning device.

The improved design provides a battery for an at least partially electrically drivable motor vehicle. The battery comprises a battery pack with a plurality of battery cells, a battery housing for receiving the battery pack, a frame enclosing the battery pack, and a pretensioning device with a pretensioning unit for applying a pretensioning force to the battery pack. A battery in the sense of the improved design in this case is preferably understood as a battery which has what is known as cell-to-pack (CTP) technology. In this case, the battery cells are not arranged in the respective cell modules, as a result of which a packing density of the battery cells and an energy density of the battery pack are increased in a particularly advantageous manner.

The battery pack, which can also be referred to as a cell pack, comprises several battery cells. In particular, the battery cells forming the battery pack can be battery cells of the type mentioned at the outset. The battery pack can have at least one battery cell, in particular between two and eight battery cells. Each of the battery cells of the battery pack has two surface areas which are connected to one another via a shell surface of the respective battery cells. Thus, each of the battery cells is delimited to the outside by the two surface areas and the shell surface, which together form a surface of each of the battery cells. The two surface areas and the shell surface can thus also be understood as delimiting surfaces of the battery. The two surface areas, which can also be referred to as so-called end surfaces, can be, for example, a bottom surface and a top surface opposite the bottom surface. In this case, each of the battery cells can in particular rest on the bottom surface, for example on a wall of the battery housing, while an electrical connection can be arranged on the top surface. The shell surface can be predetermined by a respective circumference of each of the surface areas and a height of the battery. In this context, the height can indicate a normal distance between the two surface areas. A respective shape of the surface areas and of the shell surfaces can in particular be predetermined by a design of the battery cell (for example prismatic cell, pouch cell, or cylindrical cell).

Furthermore, the battery comprises the battery housing, which has an insertion opening for receiving the battery pack. The battery housing is a sheathing of the battery, that is to say a particularly solid casing which encloses the battery pack. The battery housing, in particular, can advantageously protect the battery pack from the surroundings of the battery, and vice versa. For example, the battery housing can prevent liquid from entering the battery and, alternatively or additionally, prevent or limit the escape of gases emerging from one of the battery cells. In particular, the battery housing contains or consists of a metallic material (e.g. aluminum or steel). The insertion opening is understood to mean a recess within the battery housing in which the battery pack is arranged, i.e. positioned, after the battery has been manufactured as intended. In particular, the insertion opening can be a container that is closed on at least three sides, in particular on four or five sides, with an angular inner shape, which can be specified as a function of the shape of the battery cells. In particular, the battery housing can have a plurality of insertion openings, for example between two and six, arranged parallel to one another.

Furthermore, the battery pack is enclosed by the frame, which is designed as a hollow profile with a closed cross-section. The frame can thus enclose the battery pack in a tubular manner

In this case, the hollow profile forms a hollow body, the cross-section of which is normal as relates to a longitudinal extension direction of the hollow profile and parallel as relates to the surface areas of each battery cell, for example is circular, rectangular, or oval, at least in sections. By means of the frame, for example, the battery cells can be arranged next to one another in such a way that the battery pack is present as a single component and is particularly easy to handle during assembly (e.g. when arranged in the battery housing). In particular, the frame contains or consists of a plastic. When the frame is arranged on the battery pack, the frame at least partially covers each of the battery cells on the shell surface of the respective battery cell. Thus, the frame rests, at least in sections, on the shell surface, in particular on the end surface, of the respective battery cell, so that the frame is arranged on each of the battery cells in this area. In particular, the two surface areas may not be covered by the frame, since the hollow profile is open on both sides. In comparison to a module housing, the frame can therefore be an incomplete covering of the battery cells forming the battery pack. It is advantageous that a module housing is dispensed with and thus the manufacturing and material costs of the battery are reduced.

The battery also comprises the pretensioning device with the pretensioning unit. The pretensioning unit of the pretensioning device is designed to generate a pretensioning force on the battery pack on a first side of the frame. The pretensioning force can be between 1 and 10 kN, in particular between 2 and 5 kilonewtons. In particular, a line of action of the pretensioning force can extend normal as relates to the first side of the frame, and the pretensioning force from the environment can act in the direction of the battery pack. The pretensioning force is, for example, that force which is required to compensate for an operational swelling of at least one of the battery cells in order to advantageously increase the service life of the at least one of the battery cells and therefore of the battery pack. The pretensioning unit is thus designed to apply the pretensioning force to the battery pack after the battery has been installed at the latest.

Advantageously, the battery is particularly easy to design and manufacture according to the improved design. Because the number of components forming the battery is low compared to a modular design, the battery according to the improved design is more cost-effective, has a lower weight, and requires less space.

One advantageous embodiment provides that the pretensioning device has a further pretensioning unit which is designed to generate a further pretensioning force on the battery pack on a second side of the frame opposite the first side, so that the pretensioning force of the pretensioning unit and the further pretensioning force of the further pretensioning unit act in opposition to each other. This has the advantage that the battery pack is pretensioned particularly evenly. The pretensioning device comprises two pretensioning devices, i.e. the pretensioning device and the further pretensioning device. By means of the two pretensioning devices, a respective pretensioning force can be applied to the battery pack on a respective side of the frame assigned to the respective pretensioning device, i.e. the first pretensioning device can apply the pretensioning force on the first side of the frame and the further pretensioning device can apply the further pretensioning force on the second side. The first side and the second side are two opposite sides of the frame. In particular, the first side and the second side can be arranged parallel to one another. Furthermore, lines of action of the two pretensioning forces, i.e. those of the pretensioning force and those of the further pretensioning force, can be parallel to one another, but are oriented opposite one another. This can additionally increase the service life of the battery.

A further advantageous embodiment provides that the pretensioning device has a plate element which rests with a plate top over the entire surface on the first side of the frame and is arranged with a plate bottom on at least one pretensioned spring element. A plate element is to be understood as a level and flat component which is delimited by the top and bottom of the plate. The plate top and the plate bottom are arranged opposite one another and, in particular, parallel to one another. A normal distance between the plate top and the plate bottom is, in particular, the same over the entire plate element, i.e. the plate element is of the same thickness everywhere. The plate element is preferably dimensionally stable, i.e. a shape of the plate element is designed to be resistant (for example against compressive stress). For this purpose, the plate element can be made of a metal or a plastic, for example. This has the advantage that the pretensioning force of the pretensioning device acts particularly uniformly over the plate top on the frame. Furthermore, the pretensioning force is defined, i.e. predetermined, by the at least one spring element which is arranged on the bottom of the plate element. The at least one spring element is an elastically and/or plastically deformable component under the action of force. In particular, the spring element can be made from or contain a metal. In particular, several spring elements are provided which can be evenly distributed over the plate bottom in order to prevent tipping or tilting of the plate element when the pretensioning force is applied. In addition, the at least one spring element can have a guide element, for example a guide rail, in particular when a single spring element is present, in order to counteract the tipping or tilting of the plate element. The at least one spring element is pretensioned, which means that it is designed to output the pretensioning force directly to the outside, in particular in the direction of the battery pack. The at least one spring element has a defined spring constant and, as an alternative or in addition, a defined spring characteristic which specifies the pretensioning force. The spring characteristic describes a relationship between a force (or a torque) acting on the at least one spring element and a deflection of the at least one spring element caused thereby, i.e. its absolute extension or its rotation. The spring constant (spring stiffness) is a slope of the spring characteristic in a spring diagram. Depending on a design of the at least one spring element, the spring characteristic can be linear, progressive, degressive, or combined. This has the advantage that a spring characteristic of the at least one spring element, which is predetermined by a spring characteristic and/or the spring constant, allows the pretensioning force to be set particularly flexibly and precisely over the service life of the battery pack.

A further advantageous embodiment of this provides that the pretensioning device is connected to a further plate element via the at least one spring element. The further plate element is preferably designed analogously to the plate element already described. The at least one spring element is thus arranged between the plate element and the further plate element. As a result, the pretensioning device is advantageously designed to generate the pretensioning force by means of the plate element and a pretensioning force acting in opposition to the pretensioning force by means of the further plate element. This may be necessary, for example, if the battery has a further battery pack in addition to the battery pack, and the pretensioning device is arranged between the battery pack and the further battery pack. As a result, such a pretensioning device can particularly advantageously apply the pretensioning force to the battery pack via the plate element and can apply the oppositely acting pretensioning force to the further battery pack via the further plate element.

Alternatively or additionally, the pretensioning device is arranged directly on the battery housing. In this case, the pretensioning device can be part of the battery housing or can be integrated into the battery housing. In particular, the pretensioning device can be arranged on an end face of the insertion opening. This results in the advantage that the installation space required for the pretensioning device can be kept low. Alternatively or additionally, the at least one spring element contains a helical spring and/or a flat spring with a wavy cross-section. The helical spring can, in particular, be a metallic wire wound in a helical shape, i.e. bound. For example, the helical spring is designed as a torsionally loaded helical compression spring. The helical spring is designed to introduce the pretensioning force into the helical spring via at least one end turn of the helical spring by compressing the helical spring, to store the pretensioning force, and, when the helical spring is released, to transfer it to the battery pack via the frame. The flat spring has the wavy cross-section, so that the flat spring can correspond to a shape of a corrugated sheet. The flat spring can, for example, be punched and shaped from a spring band steel. Due to the wavy cross-section, the flat spring is curved, i.e. it can be composed of straight and circular-arc portions. Fastening the flat spring to the plate element and a weakening of the plate element resulting therefrom can be avoided. By designing the at least one spring element as a helical spring and/or as a flat spring, the pretensioning device can be designed to be particularly compact.

A further advantageous embodiment provides that the frame has two further sides, each perpendicular to the first side, which are each arranged between the battery pack and a wall of the battery housing that delimits the insertion opening. The frame can thus simulate a shape of a U-profile, the first side forming a web of the U-profile and the two other sides forming two parallel flanges of the U-profile perpendicular to the first side. The battery pack is positioned on the wall of the battery housing that delimits the insertion opening over the two other sides of the frame. In particular, the wall can comprise two longitudinal sides of the insertion opening. This results in the advantage that the battery pack can be connected to the battery housing directly or via an air gap via the two other sides, and the battery can be designed to be particularly compact.

Another advantageous embodiment provides that the battery pack has a separating element. The separating element is positioned between two battery cells adjacent to one another and is designed to thermally insulate the two adjacent battery cells from one another. The two adjacent battery cells are battery cells arranged next to one another. Alternatively, the separating element is positioned between a terminal one of the battery cells and the frame and is designed to thermally insulate the terminal one of the battery cells and the frame from one another. The terminal one of the battery cells is only adjacent to one of the other battery cells. In this context, the battery pack can, in particular, have two terminal battery cells. The separating element arranged between two of the battery cells or between one of the battery cells and the frame is designed to provide a thermal insulation function. This insulation function can, in particular, be predetermined by a material forming the separating element which has low thermal conductivity, for example less than 0.5 watts per meter and Kelvin. For example, the separating element is made of a plastic. The battery advantageously has a plurality of separating elements, so that each of the battery cells is arranged at least on one side, in particular on two sides, on a respective one of the separating elements. This results in the advantage that if at least one of the battery cells heats up or becomes overheated, a heat transfer to the battery cells that differ therefrom can be prevented, limited, or delayed.

A further advantageous embodiment for this provides that the separating element is present as a separate component or is integrated into the frame. Thus, the separating element designed as the separate component can be replaced in a particularly simple manner For example, this can be advantageous if a requirement for the insulation function of the separating element changes, and a currently installed separating element needs to be replaced with a separating element that fulfills the requirement. Alternatively, the separating element is integrated into the frame, i.e. the separating element is part of the frame. This reduces the assembly effort, since there is no need to insert the separating element, for example between the terminal one of the battery cells and the frame.

A further advantageous embodiment provides that the shell surface of each battery cell has a rectangular cross-section with two longitudinal sides and two end faces which are shorter in comparison to the longitudinal sides. In this case, two adjacent battery cells are arranged with their longitudinal sides adjacent one another. In particular, each battery cell is designed as a prismatic cell in this case. The rectangular cross-section of the shell surface is predetermined by the rectangular surface areas which extend parallel to the rectangular cross-section of the shell surface. The shell surface can, in particular, comprise four rectangular surfaces, two of the rectangular surfaces being predetermined by the longitudinal sides of the shell surface and the height of each battery cell and the other two of the rectangular surfaces being predetermined by the end faces of the shell surface and the height of each battery. Within the battery pack, each battery cell is positioned with at least one of the longitudinal sides on a further one of the battery cells. Since the longitudinal sides are longer than the end faces and thus also the two rectangular surfaces formed therefrom, a contact area between two adjacent battery cells is advantageously particularly large.

According to the improved design, a motor vehicle with a battery is also provided, the battery being designed to provide electrical power to a drive motor of the motor vehicle. The battery is preferably an advantageous embodiment of the battery according to the improved design. The motor vehicle is preferably designed as an automobile, in particular as a passenger vehicle or truck, or as a passenger bus or motorcycle. The drive motor of the motor vehicle can be designed, for example, as an electric drive or a hybrid drive.

The invention also includes refinements of the motor vehicle according to the invention, which have features as already described in the context of the refinements of the battery according to the invention. For this reason, the corresponding refinements of the motor vehicle according to the invention are not described again here.

According to the improved design, a method for manufacturing a battery is also provided. The method for manufacturing the battery can also be referred to as a manufacturing method. The battery is preferably an advantageous embodiment of the battery according to the improved design. The battery comprises a battery pack with a plurality of battery cells, each of the battery cells having two surface areas connected via a shell surface. Furthermore, the battery comprises a battery housing with an insertion opening for receiving the battery pack and a pretensioning device with a pretensioning unit.

In a first step of the method, the battery pack is enclosed by means of a frame which is designed as a hollow profile with a closed cross-section, so that each of the battery cells is at least partially covered by the frame on the shell surface of the respective battery cell. The two surface areas, however, remain uncovered.

In a second step of the method, an assembly state of the pretensioning device is set, the pretensioning unit being pretensioned and fixed in such a way that an outwardly directed pretensioning force is prevented before the pretensioning unit is arranged inside the battery housing. Once the assembly state of the pretensioning device is set, the pretensioning force is then introduced into the pretensioning unit. Fixing of the pretensioning device, which can in particular be done mechanically, prevents the pretensioning force from being transmitted to the outside, which prevents the pretensioning force from being reduced and it can be temporarily stored in the pretensioning device until the fixation is released. The second step of the method can be carried out before, after, or at the same time as the first step of the method.

In a third step of the method, the enclosed battery pack and the fixed pretensioning device are arranged in the insertion opening of the battery housing, the fixed pretensioning unit adjoining a first side of the frame. The enclosed battery pack and the fixed pretensioning device are thus positioned together within the battery housing in the insertion opening. In this case, the fixed pretensioning device and the enclosed battery pack are arranged adjacent one another via the first side of the frame.

In a fourth step of the method, an operating state of the pretensioning device arranged in the battery housing is set. The fixation of the pretensioning unit is released, in this case, so that the pretensioning force is applied to the battery pack on the first side of the frame. By transitioning the pretensioning device from the assembly state to the operating state, the pretensioning force stored in the pretensioning unit can act on the battery pack via the first side of the frame. As a result, a service life of the battery cells forming the battery pack can be increased in a particularly advantageous manner

The invention also includes refinements of the method according to the invention, which have features as already described in the context of the refinements of the battery according to the invention and/or of the motor vehicle according to the invention and vice-versa. For this reason, the corresponding refinements of the method according to the invention are not described again here.

The invention also includes the combinations of the features of the embodiments described.

### BRIEF DESCRIPTION OF THE FIGURES

Exemplary embodiments of the invention are described hereinafter. The following is shown:

FIG. 1 a schematic illustration of an exemplary embodiment of a motor vehicle according to the improved design; and

FIG. 2 a schematic sectional illustration of an exemplary embodiment of a battery according to the improved design.

### DETAILED DESCRIPTION

The exemplary embodiments explained hereinafter are preferred embodiments of the invention. In the exemplary embodiments, the described components of the embodiments each represent individual features of the invention to be considered independently of one another, each of which also refining the invention independently of one another. Therefore, the disclosure is also intended to include combinations of the features of the embodiments other than those shown. Furthermore, the described embodiments can also be supplemented by further features of the invention that have already been described.

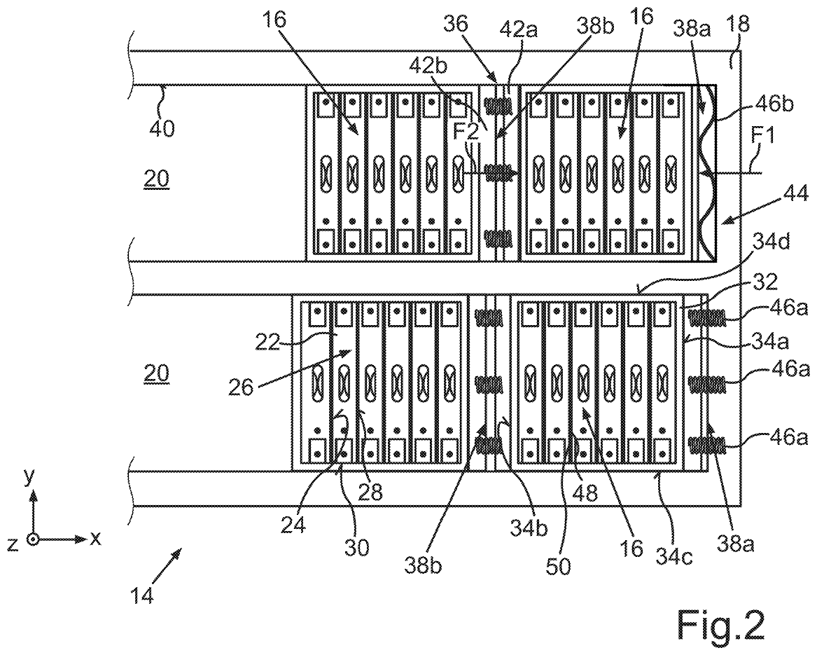

The same reference numerals designate elements that have the same function in the figures. For the sake of clarity, elements that are functionally identical and shown multiple times, in particular in FIG. 2, are provided incompletely but at least once with a corresponding reference numeral.

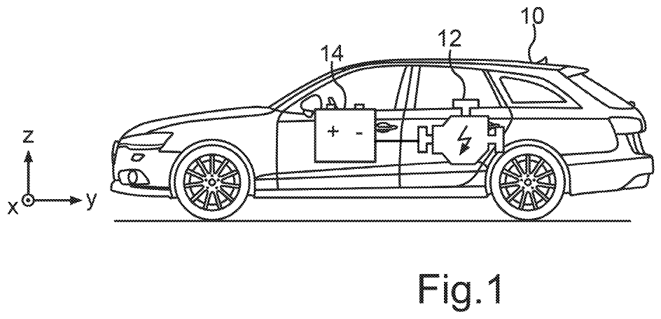

FIG. 1 shows an example of a motor vehicle 10 designed as a passenger car with a drive motor 12 and a battery 14. The battery 14 can be designed as a so-called high-voltage battery to supply the drive motor 12 with electricity. Thus, the motor vehicle 10 can be at least partially electrically drivable and the drive motor 12 can be designed as an electric drive or a hybrid drive.

FIG. 2 shows, by way of example, sections of the battery 14 in a sectional illustration in layout format with reference to the components shown and described in connection with FIG. 1. The battery 14 comprises four battery packs 16, a battery housing 18, a respective frame 32 enclosing each battery pack 16, and a pretensioning device 36.

The battery housing 18 has two insertion openings 20 for receiving the battery pack 16, the two insertion openings 20 being arranged one above the other in the y-direction. In this case, the battery packs 16 are each positioned in pairs next to one another in the x-direction, i.e. left and right, in the respective insertion opening 20. The battery packs 16 are each relatively displaceable in the x-direction and relatively immovable in the y-direction within the insertion openings 20. Each battery pack 16 comprises six battery cells 22 arranged next to one another, each battery cell 22 having two surface areas 24 which are connected to one another via a shell surface 26 of the respective battery cell 22. Overall, the battery 14 can have between 150 and 200 battery cells 22, for example. In FIG. 2, only one of the two surface areas 24, i.e. a top surface with an electrical connection, is visibly shown, while the second of the two surface areas 24, i.e. a bottom surface, is covered. In particular, each battery cell 22 can be designed as a prismatic cell, so that the two surface areas 24 are rectangular and thus the shell surface 26 of each battery cell 22 has a rectangular cross-section with two longitudinal sides 28 in the y-direction and two end faces 30 in the x-direction which are shorter as compared to the longitudinal sides 28. In this case, two adjacent battery cells 22 are arranged within the battery pack 16 with their longitudinal sides 28 adjacent one another.

Each battery pack 16 is enclosed by the frame 32, which is designed as a hollow profile with a closed cross-section, the frame 32 at least partially covering each of the battery cells 22 on the shell surface 26. In particular, each battery cell 22 is covered by the frame 32 on the end faces 30 of the shell surface 26. In addition, at the end of the battery cells 22 of each battery pack 16, one of the longitudinal sides 28, which delimits the battery pack 16 to the outside, can be covered by the frame 32. In this case, the two surface areas 24 of each of the battery cells 22 are not covered by the frame 32. The frame 32 has a first side 34a, a second side 34b opposite thereto, each in the y-direction, and two further sides 34c, 34d. The two further sides 34c, 34d are each formed perpendicular to the first side 34c and the second side 34b, i.e. in the x-direction. Thus, the longitudinal sides 28 of each battery cell 22 are parallel to the first side 34a and the second side 34b, and the end faces 30 are parallel to the two further sides 34a, 34d.

The battery 14 also has the pretensioning device 36. The pretensioning device 36 comprises a pretensioning unit 38a and a further pretensioning unit 38b. The two battery packs 16 located at the end of the insertion openings 20, i.e. the two battery packs 16 shown on the right in the x-direction and above one another in the y-direction in FIG. 2, each arranged with the first side 34a of the frame 32 on pretensioning unit 38a and with the second sides 34b of the frame 32 arranged on the further pretensioning unit 38b, and each with the further sides 34c, 34c of the frame 32 on a wall 40 delimiting the insertion opening 20. In this case, pretensioning unit 38a is designed to apply a pretensioning force F1 to the first side 34a of the frame 32 arranged thereon, which is shown schematically as an arrow extending in the direction opposite the x-direction. Similarly, the further pretensioning unit 38b is designed to apply a further pretensioning force F2 to the second side 34b of the frame 32 arranged thereon, which is shown schematically as an arrow extending in the x-direction, so that pretensioning force

F1 of pretensioning unit 38a and further pretensioning force F2 of further pretensioning unit 38b act in opposition to one another, as is shown by way of example for the battery pack 16 shown at the upper right in FIG. 2.

The pretensioning device 36 has a plate element 42a, which rests with a plate top over the entire surface on the first side 34a of the frame 32 and is arranged with a plate bottom on a pretensioned spring element 44. The at least one spring element 44 has a defined spring constant and, as an alternative or in addition, a defined spring characteristic which specifies pretensioning force F1 and further pretensioning force F2. As shown on the respective pretensioning unit 38b, the pretensioning device 36 in this case is connected to a further plate element 42b via the spring element 44, which is formed as three helical springs 46a. As an alternative or in addition, the pretensioning device 36 can be arranged directly on the battery housing 18, as shown for the respective pretensioning unit 38a. In this case, the battery pack 16 shown at the top right in FIG. 2 is fastened to the battery housing 18 via a flat spring 46b with a wavy cross-section (corrugated sheet), and the plate element 42a of the battery pack 16 shown at the bottom right is fastened to the battery housing via three further helical springs 46a.

Furthermore, the battery 14 comprises several separating elements 48 for thermal insulation. A respective separating element 48 can be positioned between two adjacent battery cells 22 in order to thermally insulate the two adjacent battery cells 22 from one another. Alternatively or additionally, separating elements 48 can each be arranged between a terminal one of the battery cells 22 and the frame 32 in order to thermally insulate the terminal one of the battery cells 22 and the frame 32 from one another. The separating elements 48 can each be present as a separate component 50 or can be integrated into the frame 32.

In a first step S1 of a method for producing the battery 14, the battery pack 16 is enclosed by means of the frame 32, so that the frame 32 at least partially covers each of the battery cells 22 on the shell surface 26 of the respective battery cell 22. In a second step S2 of the method, an assembly state of the pretensioning device 36 is set, the pretensioning unit 38a being pretensioned and fixed in such a way that an outwardly directed pretensioning force F1 is prevented before the pretensioning unit 38a is arranged inside the battery housing 18. The second step S2 of the method can be carried out before, after, or at the same time as the first step S1 of the method. In a third step S3 of the method, the enclosed battery pack 16 and the fixed pretensioning device 36 are arranged in the insertion opening 20 of the battery housing 18, the fixed pretensioning unit 38a adjoining a first side 34a of the frame 32. Alternatively or additionally, the further fixed pretensioning unit 38b can be arranged on the second side 34b of the frame 32, as shown in connection with the two battery packs 16 shown on the right in FIG. 2. In a fourth step S4 of the method, an operating state of the pretensioning device 36 arranged in the battery housing 18 is set. A fixation of the pretensioning unit 38a is released, in this case, so that the pretensioning force F1 is applied to the battery pack 16 on the first side 34a of the frame 32. If the further pretensioning unit 38a is also present, the further pretensioning force F2 on the second side 34b of the frame 32 can act in opposition to pretensioning force F1 of the pretensioning unit 38a by releasing the fixation thereof.

The improved design is based on the knowledge that the battery 14 for the motor vehicle 10, which is designed as a high-voltage battery, can currently have at least one cell module with a cell pack (battery pack 16). It is necessary that the design of at least one cell module has both a required pretension to withstand or compensate for a swelling force of the cell pack as well as thermal propagation protection, the latter being designed to prevent or delay thermal propagation of the cell pack. This can result in great effort in the manufacturing of the at least one cell module and a high weight of the battery 14 due to increased material requirements (e.g. module housing). Furthermore, due to the increased material requirement and increased manufacturing effort, the battery 14 can be cost-intensive and the design of the at least one cell module can be very complex with regard to swelling behavior over the service life of the battery 14.

The improved design is thus based on the idea that the cell pack can be inserted directly into a housing frame of the battery housing 18 in a simple support frame (frame 32). A required pretension (pretensioning force F1 and further pretensioning force F1) can be applied pretensioned over two respective plate elements 42a, 42b via the spring element 44. The required pretension can thus be set via the spring characteristic and swelling (“bulging”) of the battery cells 22 can be compensated for via the pretensioned spring element 44. This results in the advantage that the cell stack is easier to design and manufacture compared to the aforementioned at least one rigid cell module. The pretensioning force F1 and further pretensioning force F1 can also be set particularly flexibly and precisely over the service life of the battery 14. Furthermore, by omitting many module components (e.g. module housings), such a battery 14 can be manufactured particularly inexpensively, be light, and have small installation space requirements.

If rapid aging of the battery cells 22 is advantageous, the pretensioning device can also only comprise the pretensioning unit 38a, whereby an asymmetry in terms of stiffness that promotes aging can be provided, i.e. the battery housing 18 is stiffer than the plate element 40a with the spring element 44. In particular, there are two pretensioning units 38a, 38b in order to pretension the battery pack 16 and the battery cells 22 contained therein from both sides 34a, 34b with equally large pretensioning forces F1, F2.

Overall, the examples show how the battery 14 can be provided with the cell packs (battery packs 16) integrated into the battery frame, the cell packs being pretensioned via spring plates (plate elements 42a, 42b with at least one spring element 44).

1. A battery for an at least partially electrically drivable motor vehicle, comprising:
a battery pack with a plurality of battery cells, wherein each of the battery cells has two surface areas which are connected to one another via a shell surface of the respective battery cell;
a battery housing with an insertion opening for receiving the battery pack;
a frame which encloses the battery pack and is designed as a hollow profile with a closed cross-section, wherein the frame at least partially covers each of the battery cells on the shell surface of the respective battery cell; and
a pretensioning device having a pretensioning unit which is designed to apply a pretensioning force onto the battery pack on a first side of the frame.

2. The battery according to claim 1, wherein the pretensioning device has a further pretensioning unit which is designed to apply a further pretensioning force onto the battery pack on a second side of the frame, which is opposite the first side, so that the pretensioning force of the pretensioning unit and the further pretensioning force of the further pretensioning unit act in opposition to each other.

3. The battery according to claim 1, wherein the pretensioning device has a plate element which rests with a plate top over the entire surface on the first side of the frame and is arranged with a plate bottom on at least one pretensioned spring element, wherein the at least one spring element has a defined spring constant and/or a defined spring characteristic which specifies the pretensioning force.

4. The battery according to claim 3, wherein the pretensioning device is connected to a further plate element via the at least one spring element and/or is arranged directly on the battery housing, and/or
the at least one spring element contains a helical spring and/or a flat spring with a wavy cross-section.

5. The battery according to claim 1, wherein the frame has two further sides, each perpendicular to the first side, which are each arranged between the battery pack and a wall of the battery housing that delimits the insertion opening.

6. The battery according to claim 1, wherein the battery pack has a separating element which
is positioned between two battery cells adjacent to one another and is designed to thermally insulate the two adjacent battery cells from one another or
is positioned between a terminal one of the battery cells and the frame and is designed to thermally insulate the terminal one of the battery cells and the frame from one another.

7. The battery according to claim 6, wherein the separating element is present as a separate component or is integrated into the frame.

8. The battery according to claim 1, wherein the shell surface of each battery cell has a rectangular cross-section with two longitudinal sides and two end faces, which are shorter than the longitudinal sides by comparison, wherein two adjacent battery cells are arranged with their longitudinal sides adjacent one another.

9. A vehicle with a battery according to claim 1, wherein the battery is designed to supply electricity to a drive motor of the motor vehicle.

10. A method for producing a battery, wherein the battery has a battery pack with a plurality of battery cells, wherein each of the battery cells has two surface areas connected via a shell surface, wherein the battery further comprises a battery housing with an insertion opening for receiving the battery pack and a pretensioning device with a pretensioning unit, the method comprising the following steps:
enclosing the battery pack with a frame which is designed as a hollow profile with a closed cross-section, such that each of the battery cells is at least partially covered by the frame on the shell surface of the respective battery cell;
setting an assembly state of the pretensioning device, wherein the pretensioning unit is pretensioned and fixed in such a way that an outwardly directed pretensioning force is prevented before it is arranged inside the battery housing;
arranging the enclosed battery pack and the fixed pretensioning device in the insertion opening of the battery housing, wherein the fixed pretensioning unit adjoins a first side of the frame; and
setting an operating state of the pretensioning device arranged in the battery housing, wherein fixation of the pretensioning unit is released so that the pretensioning force is applied to the battery pack on the first side of the frame.

11. The battery according to claim 2, wherein the pretensioning device has a plate element which rests with a plate top over the entire surface on the first side of the frame and is arranged with a plate bottom on at least one pretensioned spring element, wherein the at least one spring element has a defined spring constant and/or a defined spring characteristic which specifies the pretensioning force.

12. The battery according to claim 2, wherein the frame has two further sides, each perpendicular to the first side, which are each arranged between the battery pack and a wall of the battery housing that delimits the insertion opening.

13. The battery according to claim 3, wherein the frame has two further sides, each perpendicular to the first side, which are each arranged between the battery pack and a wall of the battery housing that delimits the insertion opening.

14. The battery according to claim 4, wherein the frame has two further sides, each perpendicular to the first side, which are each arranged between the battery pack and a wall of the battery housing that delimits the insertion opening.

15. The battery according to claim 2, wherein the battery pack has a separating element which
is positioned between two battery cells adjacent to one another and is designed to thermally insulate the two adjacent battery cells from one another or
is positioned between a terminal one of the battery cells and the frame and is designed to thermally insulate the terminal one of the battery cells and the frame from one another.

16. The battery according to claim 3, wherein the battery pack has a separating element which
is positioned between two battery cells adjacent to one another and is designed to thermally insulate the two adjacent battery cells from one another or
is positioned between a terminal one of the battery cells and the frame and is designed to thermally insulate the terminal one of the battery cells and the frame from one another.

17. The battery according to claim 4, wherein the battery pack has a separating element which
is positioned between two battery cells adjacent to one another and is designed to thermally insulate the two adjacent battery cells from one another or
is positioned between a terminal one of the battery cells and the frame and is designed to thermally insulate the terminal one of the battery cells and the frame from one another.

18. The battery according to claim 5, wherein the battery pack has a separating element which
is positioned between two battery cells adjacent to one another and is designed to thermally insulate the two adjacent battery cells from one another or
is positioned between a terminal one of the battery cells and the frame and is designed to thermally insulate the terminal one of the battery cells and the frame from one another.

19. The battery according to claim 2, wherein the shell surface of each battery cell has a rectangular cross-section with two longitudinal sides and two end faces, which are shorter than the longitudinal sides by comparison, wherein two adjacent battery cells are arranged with their longitudinal sides adjacent one another.

20. The battery according to claim 3, wherein the shell surface of each battery cell has a rectangular cross-section with two longitudinal sides and two end faces, which are shorter than the longitudinal sides by comparison, wherein two adjacent battery cells are arranged with their longitudinal sides adjacent one another.
